(19) United States
(12) Patent Application Publication
(10) Pub. No.: US 2015/0102938 A1
(43) Pub. Date: Apr. 16, 2015

(54) Downhole Short Wavelength Radio Telemetry System for Intervention Applications

(71) Applicant: Ellen E. Read, Houston, TX (US)

(72) Inventor: Ellen E. Read, Houston, TX (US)

(73) Assignee: BAKER HUGHES INCORPORATED, Houston, TX (US)

(21) Appl. No.: 14/054,001

(22) Filed: Oct. 15, 2013

(51) Int. Cl. E21B 47/12; G01V 11/00

(52) U.S. Cl. CPC E21B 47/122; G01V 11/002
USPC 340/854.6

(57) ABSTRACT

A telemetry system and method of downhole communication is disclosed. A first electromagnetic signal propagates through a first annular region between a work string and a wellbore wall and is received at an electromagnetic receiver of a repeater. A second electromagnetic signal related to the received first electromagnetic signal is created at a processing unit coupled to the electromagnetic receiver. The second electromagnetic signal is transmitted from a transmitter of the repeater into a second annular region between the work string and the wellbore wall. The repeater may be detachably coupled to the work string and may facilitate communication between a first communication device at one of an uphole location and a downhole location and a second communication device at another of the uphole location and the downhole location.

### BACKGROUND

1. Field of the Disclosure

The present invention is related to downhole communication systems and, in particular, to a telemetry system for use in wellbore intervention processes.

2. Background of the Art

Various downhole operations in petroleum exploration and recovery employ a communication between a device at surface location and a device located in a borehole or wellbore. For example, a control unit at the surface location may control various downhole devices. Additionally, measurements taken using sensors at a downhole location may be sent uphole to the control unit for processing. Communication between the surface location and the downhole location usually employs mud pulse telemetry or electrical telemetry using electrical signals sent through wires of a wired pipe. These telemetry systems generally include a transmitter, a receiver and one or more repeaters along the borehole that aid in propagating a clean signal from the transmitter to the receiver. Such equipment may employ turbines that supply power to the transmitter, receiver and/or the one or more repeaters. The turbines may occupy a region inside a work string, thereby blocking flow of fluids through the inner region of the work string. In wellbore intervention operations, such as wellbore milling, wellbore cleanup, etc. it is necessary to have this inner region unobstructed to allow unrestricted flow of wellbore fluids.

### SUMMARY OF THE DISCLOSURE

In one aspect, the present disclosure provides a method of downhole communication, the method including: propagating a first electromagnetic signal through a first annular region between a work string and a wellbore wall; receiving the first electromagnetic signal at an electromagnetic receiver; creating a second electromagnetic signal related to the received first electromagnetic signal at a processing unit coupled to the electromagnetic receiver; and transmitting the second electromagnetic signal from a transmitter into a second annular region between the work string and the wellbore wall.

In another aspect, the present disclosure provides a repeater of a telemetry system, the repeater including: a receiver configured to receive a first electromagnetic signal propagating through a first annular region between a work string and a wellbore wall; a processor coupled to the receiver configured to create a second electromagnetic signal related to the received first electromagnetic signal; and a transmitter coupled to the processor configured to transmit the second electromagnetic signal through a second annular region between the work string and the wellbore wall.

In yet another embodiment, the present disclosure provides a telemetry system that includes: a work string; a first communication device at one of an uphole location and a downhole location; a second communication device at another of the uphole location and the downhole location; and at least one repeater coupled to the work string at a location between the first communication device and the second communication device, wherein the repeater includes: a receiver configured to receive a first electromagnetic signal propagating through a first annular region between the work string and a wellbore wall, a processor configured to create a second electromagnetic signal related to the received first electromagnetic signal, and a transmitter coupled to the processor configured to transmit the second electromagnetic signal through a second annular region between the work string and the wellbore wall.

Examples of certain features of the apparatus and method disclosed herein are summarized rather broadly in order that the detailed description thereof that follows may be better understood. There are, of course, additional features of the apparatus and method disclosed hereinafter that will form the subject of the claims appended hereto.

### BRIEF DESCRIPTION OF THE DRAWINGS

The disclosure herein is best understood with reference to the accompanying figures in which like numerals have generally been assigned to like elements and in which:

FIG. 1 shows an exemplary wellbore intervention system that includes a telemetry communication system according to one embodiment of the present disclosure;

FIG. 2 shows details of an exemplary repeater of the telemetry system of the present disclosure;

FIG. 3 shows another embodiment of a repeater of the exemplary telemetry system; and

FIG. 4 shows use of the telemetry system of the present disclosure to locate a downhole object.

### DESCRIPTION OF THE EMBODIMENTS

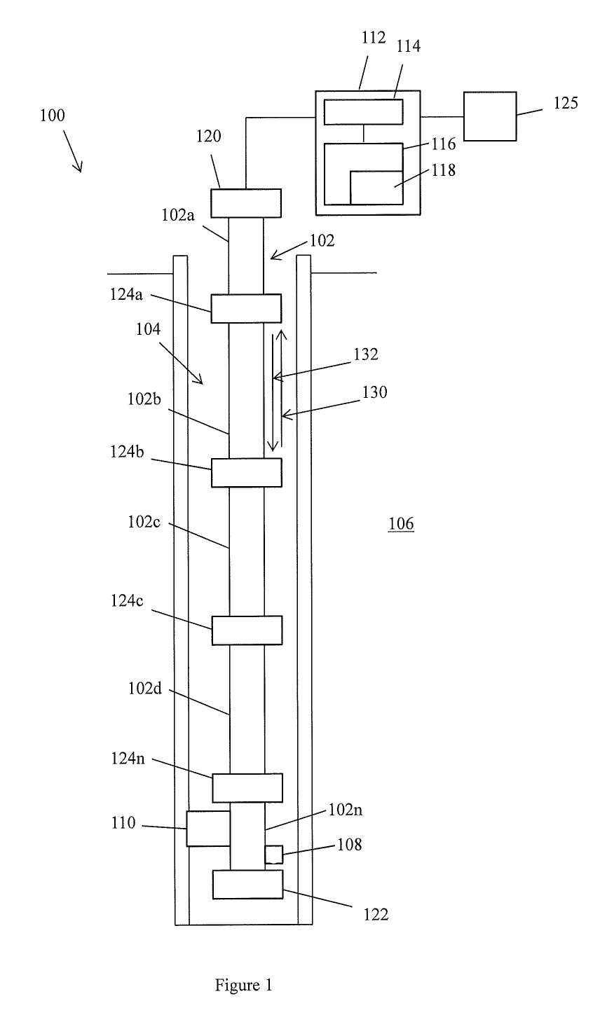

FIG. 1 shows an exemplary wellbore intervention system 100 that includes a telemetry communication system according to one embodiment of the present disclosure. The wellbore intervention system 100 includes a work string 102 disposed in a wellbore 104 formed in a formation 106. The work string 102 may be used for the purpose of performing a wellbore intervention operation, such as a casing operation, a milling operation, a wellbore cleanup operation, etc. The work string 102 may include a plurality of tubular members 102a-102n that are fit end to end. The work string 102 may include various downhole sensors 108 for obtaining a downhole measurement, such as temperature, pressure, etc. Additionally, the work string 102 may include one or more downhole tools 110 for performing the wellbore intervention operation.

The wellbore intervention system 100 may further include a control unit 112 at a surface location. The control unit 112 may include a processor 114, a memory location or memory storage device 116 for storing data obtained from a downhole operation of the tool, and one or more programs 118 stored in the memory storage device 116. When accessed by the processor 114, the one or more programs 118 enable the processor 112 to perform the methods disclosed herein for controlling the wellbore intervention operation, including the sending and receiving of messages between the control unit 112 and the downhole sensors 108 and/or downhole tools 110. The control unit 112 may be further coupled to an interface or display 125 that enables an operator to interact with the downhole sensors 108 and/or downhole tools 110.

The telemetry system includes a first communication device 120 such as transmitter for generating a signal at the surface location or at an uphole location and a second communication device 122 such as a receiver at a downhole location. In another embodiment, the first communication device 120 may include a receiver while the second communication device 122 includes a transmitter. In yet another embodiment, the first communication device 120 may include both a transmitter and a receiver while the second communication device 122 includes both a transmitter and a receiver. The telemetry system further includes repeaters (124a, 124b, 124c, . . . , 124n) disposed at various spaced-apart locations along the work string 102 for facilitating uphole communication 130 and/or downhole communication 132 between the first communication device 120 and the second communication device 122.

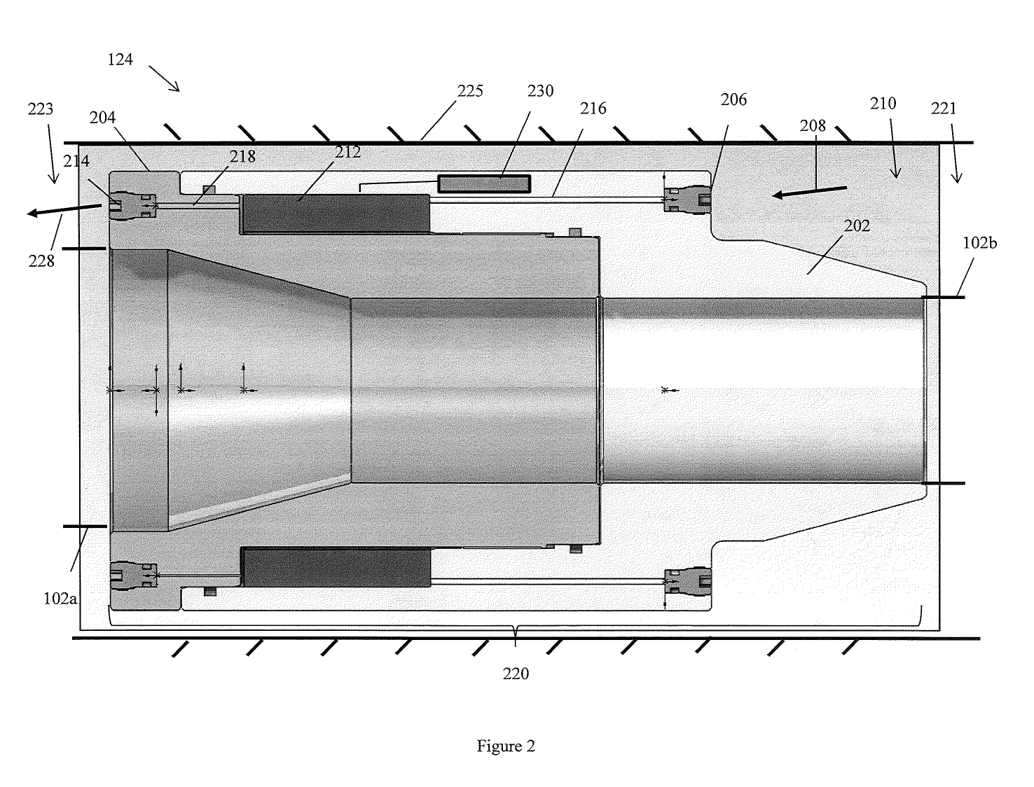

In various embodiments, the first communication device 120 and the second communication device 122 may transmit and/or receive electromagnetic signals within a short wave radio frequency band, e.g., in a frequency band between about 1,800 kiloHertz (kHz) and about 30,000 kHz. Additionally, the repeaters (124a, 124b, 124c, . . . , 124n) may operate within the short wave radio frequency band. While the invention is discussed with respect to the short wave radio frequency band, other frequency bands of the electromagnetic spectrum may be employed in other embodiments. For communication in a downhole direction, the first communication device 120 generates an electromagnetic signal and transmits the electromagnetic signal down the wellbore through an annular space between the tubular member 102 and the borehole wall. The annular space may be filled with a fluid and the electromagnetic signal is transmitted through the fluid. The generated electromagnetic signal undergoes signal loss due to the environment, including the fluid in the borehole. The electromagnetic signal is received at the first repeater 124a, processed and transmitted from the first repeater 124a to the next repeater (e.g., second repeater 124b). Processing the signal may include, for example, amplifying the signal, noise reduction, signal cleaning, etc. Each repeaters 124b, 124c, . . . 124n performs the repeating process until the repeated signal from repeater 124n is received at the second telemetry communication unit 122. Details of the repeater units (124a, 124b, 124c, . . . , 124n) are discussed below with respect to FIG. 2.

FIG. 2 shows details of an exemplary repeater 124 (e.g., repeater 124a) of the telemetry system of the present disclosure. The repeater 124 includes a first sub 202 and a second sub 204. In one embodiment, the first sub 202 may be a lower body of the repeater 124 and the second sub 204 may be an upper body of the repeater 124. The first sub 202 may be coupled to the second sub 204 to form a collar 220 that fits around an outer diameter of the work string 102 and which may be secured to the outer diameter of the work string 102. In various embodiments, the repeater 124 may be coupled to the work string 102 at a joint between a lower tubular member such as tubular member 102b and an upper tubular member such as tubular member 102a. The first sub 202 may thus be coupled to a box end of the lower tubular member 102b and the second sub 204 may be coupled to a pin end of the upper tubular member 102a. Additionally, the collar 220 may be threaded into the work string 102 at appropriate locations along the work string 102. The spacing between repeaters 124a, 124b, . . . , 124n may be related to a wavelength of the transmitted signal and/or to a range of the electromagnetic signal. The spacing between repeaters 124a, 124b, . . . , 124n may therefore be frequency-dependent. The spacing may also be selected to account for attenuation of the signal due to the fluid in the annulus.

The first sub 204 includes a receiver 206, transmitter 214, data conversion and processor sub 212 and battery 230. The receiver 206 receives a first electromagnetic signal 208 propagating through a fluid 210 in a first annular region 221 between the tubular member 102b and the wellbore wall 225. The first electromagnetic signal 208 may be a radio frequency signal or short wave radio frequency signal generated by the first communication device 120 or by a transmitter at another repeater of the telemetry system. The receiver 206 communicates the received first electromagnetic signal 208 to a data conversion and processing sub 212 via a wire 216. The data conversion and processing sub 212 performs various processing operations such as filtering the signal, signal amplification, noise reduction, etc., in order to provide a stronger signal for transmitting along the work string 102. The processed signal is sent from the data conversion and processor sub 212 to a transmitter 214 in the second sub 204 via wire 218. Coupling the first sub 202 to the second sub results in an forming an electrical connection between the data conversion and processing sub 212 and the transmitter 214. The transmitter 214 then transmits the processed signal (i.e., second electromagnetic signal 228) into the fluid in a second annular region 223 between the tubular member 102a and the borehole wall 225. The transmitter 214 generally transmits at a radio frequency of the first electromagnetic signal 208. At least one of the first electromagnetic signal 208 and the second electromagnetic signal 228 may be an encoded signal such as a morse code signal or other suitable encoded signal. The transmitter 214 and the receiver 206 may be calibrated to transmit and receiver signals over multiple frequencies. Thus, multiple data streams may be telemetered along the work string 102 using the multiple frequencies.

In one embodiment, the bottom-most repeater 124 of the telemetry system may be converted so that its receiver unit 206 is removed and replaced with one or more sensors. For this converted repeater 124, the data conversion and processor sub 212 may be programmed so as to receive data from the one or more sensors and convert the data to an electrical signal that may be converted to a short wave radio frequency signal at the transmitter 214. The converted repeater 124 may therefore be used as the second communication device 122. Alternatively, the converted repeater may be used at a selected depth along the work string 102.

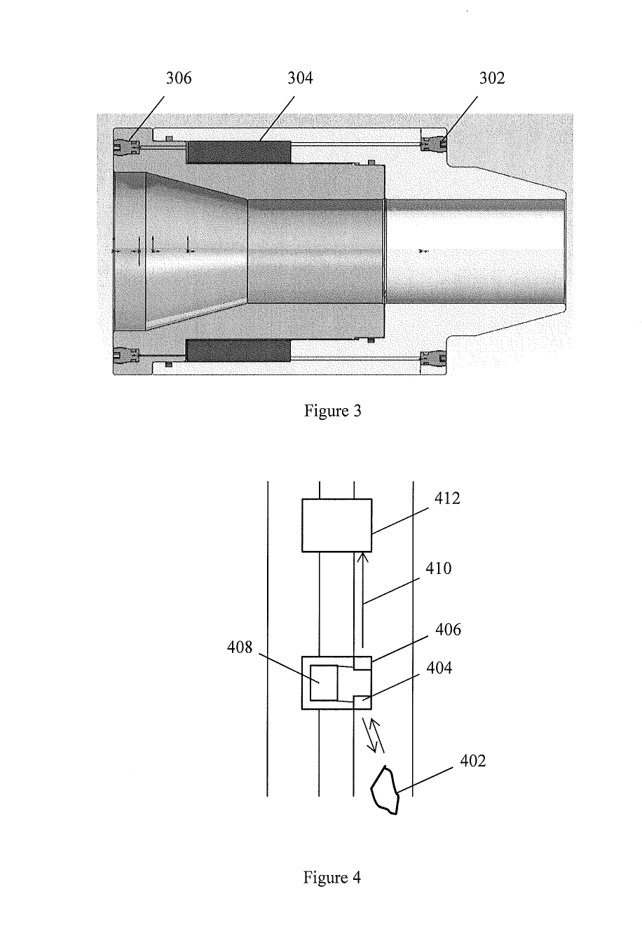

FIG. 3 shows another embodiment of a repeater 300 of the exemplary telemetry system. The repeater includes a transducer 302, a processing unit 304 and a transducer 306. The transducer 302 may include a transmitter and a receiver. Also, the transducer 306 may include a transmitter and a receiver. The transducers 302 and 304 of repeater 300 enable bi-directional communication between an uphole location and a downhole location. The repeater 300 may receive an electromagnetic signal at transducer 302, process the signal at processing unit 304 and transmit the processed signal at transducer 306. Also, the repeater 300 may receive an electromagnetic signal at transducer 306, process the signal at processing unit 304 and transmit the processed signal at transducer 302.

In the embodiments shown in FIGS. 2 and 3, the use of a battery 230 to power the receivers, transmitters and data conversion and processor subs enables that the inner bore of the work string is free of turbine machinery which otherwise occupies the inner bore. Thus, the telemetry system may be suitable for use in wellbore intervention processes in which an unobstructed inner bore is employed, such as wellbore casing, wellbore milling, wellbore cleanup, etc.

FIG. 4 shows use of the telemetry system of the present disclosure to locate a downhole object 402. In one embodiment, transducers 404 may be used to obtain a radar image of the downhole object. For example, transducer 404 may transmit an electromagnetic signal into the wellbore and receive a reflection of the electromagnetic signal from the downhole object 402 to obtain a downhole radar signal. The processor 408 may thus use the radar signal to determine a location of the downhole object 402, thereby enabling fishing operations. The processor 408 may the prepare a signal based on the radar signal and send the signal to the transmitter 406. The transmitter converts the signal to a short wave radio frequency signal 410 and transmits the short wave radio frequency signal 410 uphole to repeater 412 or other communication equipment.

Therefore, in one aspect the present disclosure provides a method of downhole communication, the method including: propagating a first electromagnetic signal through a first annular region between a work string and a wellbore wall; receiving the first electromagnetic signal at an electromagnetic receiver; creating a second electromagnetic signal related to the received first electromagnetic signal at a processing unit coupled to the electromagnetic receiver; and transmitting the second electromagnetic signal from a transmitter into a second annular region between the work string and the wellbore wall. The receiver and the transmitter may be coupled to an exterior face of the work string. The receiver and the transmitter may be part of a collar that may be detachably coupled to an exterior of the work string. The detachable collar may include a first sub that includes the receiver and a second sub that includes the transmitter. The first sub may be coupled to a box end of a first tubular member of the work string and the second end may be coupled to a pin end of a second tubular member of the work string that joins with the box end. In various embodiments, the first electromagnetic signal and the second electromagnetic signal may include a telemetry signal, an encoded signal, a portion of a morse code signal, and/or a short wave radio frequency signal. In one embodiment, the first electromagnetic signal may be a radar signal reflected from a downhole component.

In another aspect, the present disclosure provides a repeater of a telemetry system, the repeater including: a receiver configured to receive a first electromagnetic signal propagating through a first annular region between a work string and a wellbore wall; a processor coupled to the receiver configured to create a second electromagnetic signal related to the received first electromagnetic signal; and a transmitter coupled to the processor configured to transmit the second electromagnetic signal through a second annular region between the work string and the wellbore wall. The receiver, the processor and/or the transmitter may be located in a collar that may be detachably coupled to an exterior face of the work string. The collar further includes a first sub including the receiver and a second sub including the transmitter. For a work string that include a first tubular member with a box end and a second tubular member that includes a pin end, wherein the pin end joins to the box end, the first sub may be coupled to the box end of the first tubular member and the second end may be coupled to the pin end of the second tubular member. The first sub and the second sub may be coupled to produce a communication link between the processor at least one of the receiver and the transmitter. The first electromagnetic signal and the second electromagnetic signal may include: a telemetry signal, an encoded signal, a portion of a morse code signal and/or a short wave radio frequency signal. In one embodiment, the first electromagnetic signal is a radar signal reflected from a downhole component.

In yet another embodiment, the present disclosure provides a telemetry system that includes: a work string; a first communication device at one of an uphole location and a downhole location; a second communication device at another of the uphole location and the downhole location; and at least one repeater coupled to the work string at a location between the first communication device and the second communication device, wherein the repeater includes: a receiver configured to receive a first electromagnetic signal propagating through a first annular region between the work string and a wellbore wall, a processor configured to create a second electromagnetic signal related to the received first electromagnetic signal, and a transmitter coupled to the processor configured to transmit the second electromagnetic signal through a second annular region between the work string and the wellbore wall. The first electromagnetic signal may be a signal transmitted by the first communication device or by a transmitter of another repeater of the telemetry system. The second electromagnetic signal may be a signal transmitted to a receiver of another repeater of the telemetry system or to the second communication device. The repeater may further include a collar that is detachably coupled to an exterior face of the work string. The collar further may include a first sub that includes the receiver and a second sub that includes the transmitter. The first sub may be coupled to a box end of a first tubular member of the work string and the second end is coupled to a pin end of a second tubular member of the work string, wherein the pin end joins with the box end to coupled the first tubular member to the second tubular member. Coupling the first sub to the second sub may form a communication link between the processor and at least one of the receiver and the transmitter. The first electromagnetic signal and/or the second electromagnetic signal may include at least one of: a telemetry signal, an encoded signal, a portion of a morse code signal, and a short wave radio frequency signal In one embodiment, the first electromagnetic signal may include a radar signal reflected from a downhole component.

While the foregoing disclosure is directed to the certain exemplary embodiments of the disclosure, various modifications will be apparent to those skilled in the art. It is intended that all variations within the scope and spirit of the appended claims be embraced by the foregoing disclosure.

What is claimed is:

1. A method of downhole communication, comprising:
propagating a first electromagnetic signal through a first annular region between a work string and a wellbore wall;
receiving the first electromagnetic signal at an electromagnetic receiver;
creating a second electromagnetic signal related to the received first electromagnetic signal at a processing unit coupled to the electromagnetic receiver; and
transmitting the second electromagnetic signal from a transmitter into a second annular region between the work string and the wellbore wall.

2. The method of claim 1, wherein the receiver and the transmitter are coupled to an exterior face of the work string.

3. The method of claim 1, further comprising coupling a detachable collar that includes the receiver and the transmitter to the exterior of the work string.

4. The method of claim 3, wherein the detachable collar comprises a first sub including the receiver and a second sub including the transmitter.

5. The method of claim 4, wherein the first sub is coupled to a box end of a first tubular member of the work string and the second end is coupled to a pin end of a second tubular member of the work string, wherein the pin end joins with the box end.

6. The method of claim 1, wherein at least one of the first electromagnetic signal and the second electromagnetic signal further comprises (i) a telemetry signal; (ii) an encoded signal; (iii) a portion of a morse code signal; and (iv) a short wave radio frequency signal.

7. The method of claim 1, wherein the first electromagnetic signal is a radar signal reflected from a downhole component.

8. A repeater of a telemetry system, comprising:
a receiver configured to receive a first electromagnetic signal propagating through a first annular region between a work string and a wellbore wall;
a processor coupled to the receiver configured to create a second electromagnetic signal related to the received first electromagnetic signal; and
a transmitter coupled to the processor configured to transmit the second electromagnetic signal through a second annular region between the work string and the wellbore wall.

9. The repeater of claim 8, wherein at least one of the receiver, processor and transmitter are located in a collar that is detachably coupled to an exterior face of the work string.

10. The repeater of claim 9, wherein the collar further comprises a first sub including the receiver and a second sub including the transmitter, wherein the first sub is coupled to a box end of a first tubular member of the work string and the second end is coupled to a pin end of a second tubular member of the work string, wherein the pin end joins with the box end.

11. The repeater of claim 10, wherein the first sub and the second sub are coupled to produce a communication link between the processor at least one of the receiver and the transmitter.

12. The repeater of claim 8, wherein at least one of the first electromagnetic signal and the second electromagnetic signal further comprises (i) a telemetry signal; (ii) an encoded signal; (iii) a portion of a morse code signal; and (iv) a short wave radio frequency signal.

13. The repeater of claim 8, wherein the first electromagnetic signal is a radar signal reflected from a downhole component.

14. A telemetry system, comprising:
a work string;
a first communication device at one of an uphole location and a downhole location;
a second communication device at another of the uphole location and the downhole location; and
at least one repeater coupled to the work string at a location between the first communication device and the second communication device, wherein the repeater includes:
a receiver configured to receive a first electromagnetic signal propagating through a first annular region between the work string and a wellbore wall,
a processor configured to create a second electromagnetic signal related to the received first electromagnetic signal, and
a transmitter coupled to the processor configured to transmit the second electromagnetic signal through a second annular region between the work string and the wellbore wall.

15. The telemetry system of claim 14, wherein at least one of: (i) the first electromagnetic signal is a signal transmitted by the first communication device; (ii) the first electromagnetic signal is transmitted by a transmitter of another repeater of the telemetry system; (iii) the second electromagnetic signal is transmitted to a receiver of another repeater of the telemetry system; and (iv) the second electromagnetic signal is transmitted to the second communication device.

16. The telemetry system of claim 14, wherein the repeater further comprises a collar that is detachably coupled to an exterior face of the work string.

17. The telemetry system of claim 16, wherein the collar further comprises a first sub including the receiver and a second sub including the transmitter, wherein the first sub is coupled to a box end of a first tubular member of the work string and the second end is coupled to a pin end of a second tubular member of the work string, wherein the pin end joins with the box end.

18. The telemetry system of claim 17, wherein the first sub and the second sub are coupled to produce a communication link between the processor and at least one of the receiver and the transmitter.

19. The telemetry system of claim 14, wherein at least one of the first electromagnetic signal and the second electromagnetic signal further comprises (i) a telemetry signal; (ii) an encoded signal; (iii) a portion of a morse code signal; and (iv) a short wave radio frequency signal.

20. The telemetry system of claim 14, wherein the first electromagnetic signal further comprises a radar signal reflected from a downhole component.
